(19) United States
(12) Patent Application Publication
(10) Pub. No.: US 2013/0223612 A1
(43) Pub. Date: Aug. 29, 2013

(54) DYNAMIC ADJUSTMENT OF MULTI-DIMENSIONAL ROUTING RULE

(71) Applicants: Andrew D. Flockhart, Thornton, CO (US); Robert C. Steiner, Broomfield, CO (US); Joylee Kohler, Northglenn, CO (US)

(72) Inventors: Andrew D. Flockhart, Thornton, CO (US); Robert C. Steiner, Broomfield, CO (US); Joylee Kohler, Northglenn, CO (US)

(73) Assignee: AVAYA INC., Basking Ridge, NJ (US)

(21) Appl. No.: 13/408,806

(22) Filed: Feb. 29, 2012

(51) Int. Cl. H04M 3/00

(52) U.S. Cl. 379/265.02

(57) ABSTRACT

A contact center is described along with various methods and mechanisms for administering the same. The contact center proposed herein provides the ability to, among other things, support the ability to flexibly apply a plurality of different work assignment algorithms simultaneously, weight work item routing decisions received from each work assignment algorithm, and then make a final work item routing decision based on a weighted combination of the work item routing decisions.

### FIELD OF THE DISCLOSURE

The present disclosure is generally directed toward communications and more specifically toward contact centers.

### BACKGROUND

Current contact centers are only configured to execute a single routing algorithm at any given time for a given contact type (skill). However, as the contact center experiences variations in traffic, the routing algorithm that was used may result in the contact center under-performing. Imagine a spectrum of routing algorithms where one extreme routing algorithm values speed at the expense of quality whereas another extreme routing algorithm values quality at the expense of speed. While there are many algorithms along the spectrum, each algorithm is static and is only optimal for a specific set of contact center conditions.

As can be appreciated, it is difficult to select the best routing algorithm for a contact center, especially if the routing algorithm has to be selected in advance and without actual knowledge of the contact center conditions.

### SUMMARY

It is with respect to the above issues and other problems that the embodiments presented herein were contemplated. In particular, embodiments of the present disclosure provide the ability to mix multiple different work assignment algorithms and vary the input weights of those algorithms depending upon current conditions of the contact center.

Systems have been described that allow for the creation of customized mixed algorithms. In particular, U.S. Patent Publication No. 2011/0078329 to Steiner, the entire contents of which are hereby incorporated herein by reference, teaches that multiple existing algorithms can be mixed according to a customer's needs to create a customized mixed algorithm. Solutions are provided for dynamically selecting two or more different and existing algorithms to be mixed into a single algorithm. According to the '329 publication, arbitration rules can be invoked to determine which algorithm in the set of existing algorithms will supersede the other algorithms in the event of a conflict.

Embodiments of the present disclosure build on the concepts of the '329 publication. In particular, embodiments of the present disclosure enable multiple work assignment algorithms to operate independently and provide a routing decision according to the logic of that algorithm. The routing decisions made by each of the algorithms may then be weighted or otherwise adjusted based, at least in part, on current contact center conditions. The weighted outputs of each algorithm (e.g., the weighted routing decisions) may then be analyzed simultaneously and results of the analysis will achieve a single routing decision that has accounted for the multiple algorithms.

Traditional routing solutions use agent skill levels, which are a measure of the proficiency of an agent at a specific task. Proficiency normally includes a combination of both effectiveness and speed (efficiency) of the agent. This confined notion is used statically under all contact center conditions. Embodiments of the present disclosure, however, employ a dynamic definition of proficiency, which favors effectiveness when the contact center is quiet (e.g., when traffic is relatively low and the contact center is generally meeting its time-based Service Level Objectives) and speed when the contact center is overloaded (e.g., when traffic is relatively high and the contact center is failing to meet one or more of its time-based Service Level Objectives).

In some embodiments, a pendulum of rules is applied for work assignment decisions. The ratio in which the various work assignment decisions are applied may be dependent upon whether contact center is busy, overloaded, etc. and they may be a combination of effectiveness-sensitive and time-sensitive algorithms. In particular, a contact center is suggested that can adjust its routing behavior dynamically by applying different weights of static rules that can achieve different goals.

In some embodiments, a preference of speed and effectiveness is computed and the weighting depends on current contact center state. The weighting then controls what routing algorithms should be used and in what combination to use them. In some embodiments, the contact center will continually adjust the weighting of the different rules based on the current state of the contact center and current goals for the contact center (e.g., balancing effective vs. efficient). There may be a static set of rules that try to match with the definition of best, but the definition of best is continually changing.

Accordingly, a contact center is proposed which is able to choose the best combination of static algorithms at any given moment based on the current state of the contact center.

In one variation of the embodiments described herein, a single algorithm may be used instead of multiple algorithms. This single algorithm may comprise multiple different metrics in its calculations. The metrics within this single algorithm may be weighted differently relative to one another depending upon the current state of the contact center.

In accordance with at least some embodiments of the present disclosure, a method is provided which generally comprises:

receiving a first work item routing decision from a first work assignment algorithm, the first work item routing decision being made by the first work assignment algorithm based on the first work assignment algorithm receiving a first set of inputs and processing the first set of inputs according to a first logic;

receiving a second work item routing decision from a second work assignment algorithm, the second work item routing decision being made by the second work assignment algorithm based on the second work assignment algorithm receiving a second set of inputs and processing the second set of inputs according to a second logic that is different than the first logic;

determining a current state of a contact center;

based on the current state of the contact center, making a final work item routing decision that is based on a weighted combination of the first and second work item routing decisions.

As used herein, the term “work item routing decision” is used to refer to a decision made by a work assignment engine to assign a work item to an agent or vice versa. Specifically, a work item routing decision can be made in response to an agent becoming available for new work or in response to a new work item arriving in the contact center that has one or more currently-available agents.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

The term “computer-readable medium” as used herein refers to any tangible storage that participates in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, or any other medium from which a computer can read. When the computer-readable media is configured as a database, it is to be understood that the database may be any type of database, such as relational, hierarchical, object-oriented, and/or the like. Accordingly, the disclosure is considered to include a tangible storage medium and prior art-recognized equivalents and successor media, in which the software implementations of the present disclosure are stored.

The terms “determine”, “calculate”, and “compute,” and variations thereof, as used herein, are used interchangeably and include any type of methodology, process, mathematical operation or technique.

The term “module” as used herein refers to any known or later developed hardware, software, firmware, artificial intelligence, fuzzy logic, or combination of hardware and software that is capable of performing the functionality associated with that element. Also, while the disclosure is described in terms of exemplary embodiments, it should be appreciated that individual aspects of the disclosure can be separately claimed.

### BRIEF DESCRIPTION OF THE DRAWINGS

The present disclosure is described in conjunction with the appended figures:

FIG. 1 is a block diagram of a communication system in accordance with embodiments of the present disclosure;

FIG. 2 is a block diagram depicting pools and bitmaps that are utilized in accordance with embodiments of the present disclosure;

FIG. 3 is a block diagram depicting additional details of a work assignment engine in accordance with embodiments of the present disclosure;

FIG. 4 is a schematic diagram depicting a first set of weighting adjustments that can be made based on contact center state in accordance with embodiments of the present disclosure;

FIG. 5 is a schematic diagram depicting a second set of weighting adjustment that can be made based on contact center state in accordance with embodiments of the present disclosure;

FIG. 6 is a flow diagram depicting a work assignment method in accordance with embodiments of the present disclosure; and

FIG. 7 is a flow diagram depicting a method of weighting routing decisions from multiple different work assignment algorithms in accordance with embodiments of the present disclosure.

### DETAILED DESCRIPTION

The ensuing description provides embodiments only, and is not intended to limit the scope, applicability, or configuration of the claims. Rather, the ensuing description will provide those skilled in the art with an enabling description for implementing the embodiments. It being understood that various changes may be made in the function and arrangement of elements without departing from the spirit and scope of the appended claims.

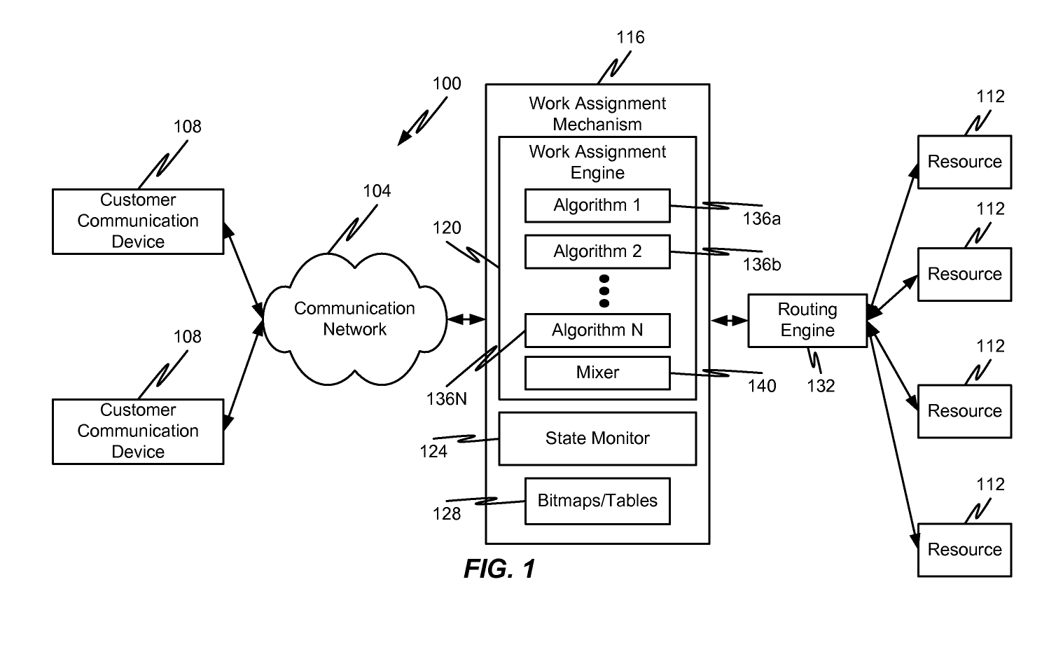

FIG. 1 shows an illustrative embodiment of a communication system 100 in accordance with at least some embodiments of the present disclosure. The communication system 100 may be a distributed system and, in some embodiments, comprises a communication network 104 connecting one or more communication devices 108 to a work assignment mechanism 116, which may be owned and operated by an enterprise administering a contact center in which a plurality of resources 112 are distributed to handle incoming work items (in the form of contacts) from the customer communication devices 108.

In accordance with at least some embodiments of the present disclosure, the communication network 104 may comprise any type of known communication medium or collection of communication media and may use any type of protocols to transport messages between endpoints. The communication network 104 may include wired and/or wireless communication technologies. The Internet is an example of the communication network 104 that constitutes an Internet Protocol (IP) network consisting of many computers, computing networks, and other communication devices located all over the world, which are connected through many telephone systems and other means. Other examples of the communication network 104 include, without limitation, a standard Plain Old Telephone System (POTS), an Integrated Services Digital Network (ISDN), the Public Switched Telephone Network (PSTN), a Local Area Network (LAN), a Wide Area Network (WAN), a Session Initiation Protocol (SIP) network, a cellular network, and any other type of packet-switched or circuit-switched network known in the art. In addition, it can be appreciated that the communication network 104 need not be limited to any one network type, and instead may be comprised of a number of different networks and/or network types. As one example, embodiments of the present disclosure may be utilized to increase the efficiency of a grid-based contact center. Examples of a grid-based contact center are more fully described in U.S. patent application Ser. No. 12/469,523 to Steiner, the entire contents of which are hereby incorporated herein by reference. Moreover, the communication network 104 may comprise a number of different communication media such as coaxial cable, copper cable/wire, fiber-optic cable, antennas for transmitting/receiving wireless messages, and combinations thereof.

The communication devices 108 may correspond to customer communication devices. In accordance with at least some embodiments of the present disclosure, a customer may utilize their communication device 108 to initiate a work item, which is generally a request for a processing resource 112. Exemplary work items include, but are not limited to, a contact directed toward and received at a contact center, a web page request directed toward and received at a server farm (e.g., collection of servers), a media request, an application request (e.g., a request for application resources location on a remote application server, such as a SIP application server), and the like. The work item may be in the form of a message or collection of messages transmitted over the communication network 104. For example, the work item may be transmitted as a telephone call, a packet or collection of packets (e.g., IP packets transmitted over an IP network), an email message, an Instant Message, an SMS message, a fax, and combinations thereof.

In some embodiments, the communication may not necessarily be directed at the work assignment mechanism 116, but rather may be on some other server in the communication network 104 where it is harvested by the work assignment mechanism 116, which generates a work item for the harvested communication. An example of such a harvested communication includes a social media communication that is harvested by the work assignment mechanism 116 from a social media network or server. Exemplary architectures for harvesting social media communications and generating work items based thereon are described in U.S. patent application Ser. Nos. 12/784,369, 12/706,942, and 12/707,277, filed Mar. 20, 1010, Feb. 17, 2010, and Feb. 17, 2010, respectively, each of which are hereby incorporated herein by reference in their entirety.

The format of the work item may depend upon the capabilities of the communication device 108 and the format of the communication. In some embodiments, work items are logical representations within a contact center of work to be performed in connection with servicing a communication received at the contact center (and more specifically the work assignment mechanism 116). The communication associated with a work item may be received and maintained at the work assignment mechanism 116, a switch or server connected to the work assignment mechanism 116, or the like until a resource 112 is assigned to the work item representing that communication at which point the work assignment mechanism 116 passes the work item to a routing engine 132 to connect the communication device 108 which initiated the communication with the assigned resource 112.

Although the routing engine 132 is depicted as being separate from the work assignment mechanism 116, the routing engine 132 may be incorporated into the work assignment mechanism 116 or its functionality may be executed by the work assignment engine 120.

In accordance with at least some embodiments of the present disclosure, the communication devices 108 may comprise any type of known communication equipment or collection of communication equipment. Examples of a suitable communication device 108 include, but are not limited to, a personal computer, laptop, Personal Digital Assistant (PDA), cellular phone, smart phone, telephone, or combinations thereof. In general each communication device 108 may be adapted to support video, audio, text, and/or data communications with other communication devices 108 as well as the processing resources 112. The type of medium used by the communication device 108 to communicate with other communication devices 108 or processing resources 112 may depend upon the communication applications available on the communication device 108.

In accordance with at least some embodiments of the present disclosure, the work item is sent toward a collection of processing resources 112 via the combined efforts of the work assignment mechanism 116 and routing engine 132. The resources 112 can either be completely automated resources (e.g., Interactive Voice Response (IVR) units, processors, servers, or the like), human resources utilizing communication devices (e.g., human agents utilizing a computer, telephone, laptop, etc.), or any other resource known to be used in contact centers.

As discussed above, the work assignment mechanism 116 and resources 112 may be owned and operated by a common entity in a contact center format. In some embodiments, the work assignment mechanism 116 may be administered by multiple enterprises, each of which has their own dedicated resources 112 connected to the work assignment mechanism 116.

In some embodiments, the work assignment mechanism 116 comprises a work assignment engine 120 which enables the work assignment mechanism 116 to make intelligent routing decisions for work items. In some embodiments, the work assignment engine 120 is configured to administer and make work assignment decisions in a queueless contact center, as is described in U.S. patent application Ser. No. 12/882,950, the entire contents of which are hereby incorporated herein by reference.

More specifically, the work assignment engine 120 can generate bitmaps/tables 128 and determine, based on an analysis of the bitmaps/tables 128, which of the plurality of processing resources 112 is eligible and/or qualified to receive a work item and further determine which of the plurality of processing resources 112 is best suited to handle the processing needs of the work item. As will be discussed in further detail herein, the work assignment engine 120 may comprise a mixer140 to mix routing decisions made by multiple different work assignment algorithms 136a-N. The manner in which the mixer 140 mixes the multiple different routing decisions from the multiple different work assignment algorithms 136a-N may vary according to contact center state.

In situations of work item surplus, the work assignment engine 120 can also make the opposite determination (i.e., determine optimal assignment of a work item to a resource). In some embodiments, the work assignment engine 120 is configured to achieve true one-to-one matching by utilizing the bitmaps/tables 128 and any other similar type of data structure.

The work assignment engine 120 may reside in the work assignment mechanism 116 or in a number of different servers or processing devices. In some embodiments, cloud-based computing architectures can be employed whereby one or more components of the work assignment mechanism 116 are made available in a cloud or network such that they can be shared resources among a plurality of different users.

In addition to comprising the work assignment engine 120, the work assignment mechanism 116 may also comprise a state monitor 124. The state monitor 124 may be configured to monitor and assess the state of the contact center 100 on a continual or periodic basis and provide results of its assessment to the work assignment engine 120. Specifically, the state monitor 124 may provide its analysis information to the mixer 140 to assist the mixer 140 in adjusting the manner in which routing decisions from the work assignment algorithms 136a-N are mixed.

Specifically, the state monitor 124 may be responsible for monitoring one or more agent performance metrics (e.g., KPIs, schedule adherence, overall profitability, skill improvements, etc.) for some or all agents in the contact center 100 and comparing those metrics with one or more Service Level Objectives or SLOs. The results of these comparisons may be provided to the mixer 140 where they are used to adjust the ratio of weights applied to various routing decisions received at the mixer 140 from the various work assignment algorithms 136a-N.

Information monitored by the state monitor 124 may include information which describes an agent's current or historical (e.g., past hour, day, week, month, quarter, year, recently-handled contact, etc.) performance within the contact center. In some embodiments, the KPI information is obtained from the work assignment engine 120 or from some other analysis and reporting module running within the contact center. As used herein, KPIs may include, without limitation, any metric or combination of metrics that define performance of an entity within a contact center (e.g., a contact center agent, a group of contact center agents, etc.). Specifically, a KPI can be defined in terms of making progress toward strategic goals or simply the repeated achievement of some level of an operational goal.

In a contact center context, KPIs may vary depending upon whether work items correspond to outbound contacts (e.g., contacts originated by the contact center) or inbound contacts (e.g., contacts received at the contact center that have been originated outside the contact center). Non-limiting examples of outbound contact KPIs include: Contacts per hour—Average number of customers a call center agent was able to contact within an hour; Leads Conversion Rate—The percentage of leads that actually converted to sales; Hourly Sales—The average amount of sales the call center representative was able to close in an hour; Daily Sales—The average value of sales the agent was able to close in a day; and Accuracy—Extent to which a contact has been handled according to a predetermined script.

Non-limiting examples of inbound contact KPIs include: Real time Q—Metrics; Calls per hour—The average number of calls the agent is able to take per hour; Saves/One-Call Resolutions—The number of times our agents are able to resolve an issue immediately within the first phone call. Colloquially referred to as “one-and-done” calls; Average Handle Time—How long it takes for one call to be handled, which includes the call time itself, plus the work done after that call; Average Wait Time—How long a caller is put on hold before a call center agent becomes available to take the call; Accuracy; Abandonment Rate—This is the percentage of customers who disconnected before an agent was able to intercept the call; and Completion Rate—The ratio of successfully finished calls to the number of attempted calls by the customer.

Other types of KPIs that are not necessarily specific to inbound or outbound contacts include, without limitation, customer satisfaction level, customer service level, average speed of answer, contact forecast precision level, quality of services rendered, average handling cost of a contact, agent occupancy ratio, schedule adherence and conformity, and time distribution (in service, non-service detailed time or “shrinkage”). Other examples include number of times calls are put on hold, number of transfers, $/min, $/call, number of upsells, number of cross-sells, etc.

As can be appreciated, the state monitor 124 and/or bitmaps/tables 128 may be internal to the work assignment mechanism 116 or they may be separate from the work assignment mechanism 116. Likewise, certain components of the work assignment engine 120 (e.g., work assignment algorithms 136a-N and mixer 140) do not necessarily need to be executed within the work assignment engine 120 and may be executed in different parts of the contact center 100.

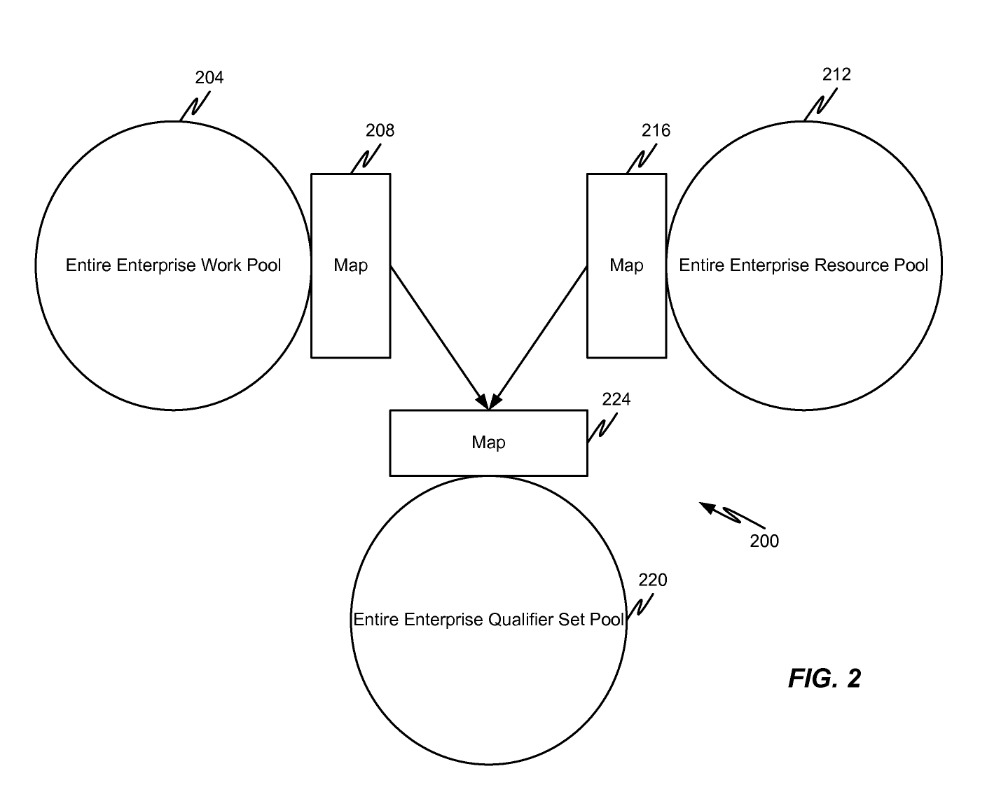

FIG. 2 depicts exemplary data structures 200 which may be incorporated in or used to generate the bitmaps/tables 128 used by the work assignment engine 120. The exemplary data structures 200 include one or more pools of related items. In some embodiments, three pools of items are provided, including an enterprise work pool 204, an enterprise resource pool 212, and an enterprise qualifier set pool 220. The pools are generally an unordered collection of like items existing within the contact center. Thus, the enterprise work pool 204 comprises a data entry or data instance for each work item within the contact center 100 at any given time.

In some embodiments, the population of the work pool 204 may be limited to work items waiting for service by or assignment to a resource 112, but such a limitation does not necessarily need to be imposed. Rather, the work pool 204 may contain data instances for all work items in the contact center regardless of whether such work items are currently assigned and being serviced by a resource 112 or not. The differentiation between whether a work item is being serviced (i.e., is assigned to a resource 112) may simply be accounted for by altering a bit value in that work item's data instance. Alteration of such a bit value may result in the work item being disqualified for further assignment to another resource 112 unless and until that particular bit value is changed back to a value representing the fact that the work item is not assigned to a resource 112, thereby making that resource 112 eligible to receive another work item.

Similar to the work pool 204, the resource pool 212 comprises a data entry or data instance for each resource 112 within the contact center. Thus, resources 112 may be accounted for in the resource pool 212 even if the resource 112 is ineligible due to its unavailability because it is assigned to a work item or because a human agent is not logged-in. The ineligibility of a resource 112 may be reflected in one or more bit values.

The qualifier set pool 220 comprises a data entry or data instance for each qualifier set within the contact center. In some embodiments, the qualifier sets within the contact center are determined based upon the attributes or attribute combinations of the work items in the work pool 204. Qualifier sets generally represent a specific combination of attributes for a work item. In particular, qualifier sets can represent the processing criteria for a work item and the specific combination of those criteria. Each qualifier set may have a corresponding qualifier set identified “qualifier set ID” which is used for mapping purposes. As an example, one work item may have attributes of language=French and intent=Service and this combination of attributes may be assigned a qualifier set ID of “12” whereas an attribute combination of language=English and intent=Sales has a qualifier set ID of “13.” The qualifier set IDs and the corresponding attribute combinations for all qualifier sets in the contact center may be stored as data structures or data instances in the qualifier set pool 220.

In some embodiments, one, some, or all of the pools may have a corresponding bitmap. Thus, a contact center may have at any instance of time a work bitmap 208, a resource bitmap 216, and a qualifier set bitmap 224. In particular, these bitmaps may correspond to qualification bitmaps which have one bit for each entry. Thus, each work item in the work pool 204 would have a corresponding bit in the work bitmap 208, each resource 112 in the resource pool 212 would have a corresponding bit in the resource bitmap 216, and each qualifier set in the qualifier set pool 220 may have a corresponding bit in the qualifier set bitmap 224.

In some embodiments, the bitmaps are utilized to speed up complex scans of the pools and help each work assignment algorithm 136a-N in the work assignment engine 120 make an optimal work item/resource assignment decision based on the current state of each pool. The decision made by each algorithms 136a-N at any given time does not necessarily have to be the same decision, thereby providing the ability to invoke services of the mixer 140 to come to a final routing decision. In some embodiments, each algorithm 136a-N may use different bits within the same bitmaps to make a routing decision at substantially the same time. In this way, each algorithm is allowed to make a routing decision based on the same instance of contact center data as reflected in the bitmaps. Since each algorithm 136a-N is configured to make a routing decision at substantially the same time, it is useful to update the values in the bitmaps in-between the times when a routing decision is made. Accordingly, the values in the bitmaps 208, 216, 224 may be recalculated each time the state of a pool changes (e.g., when a work item surplus is detected, when a resource surplus is detected, etc.).

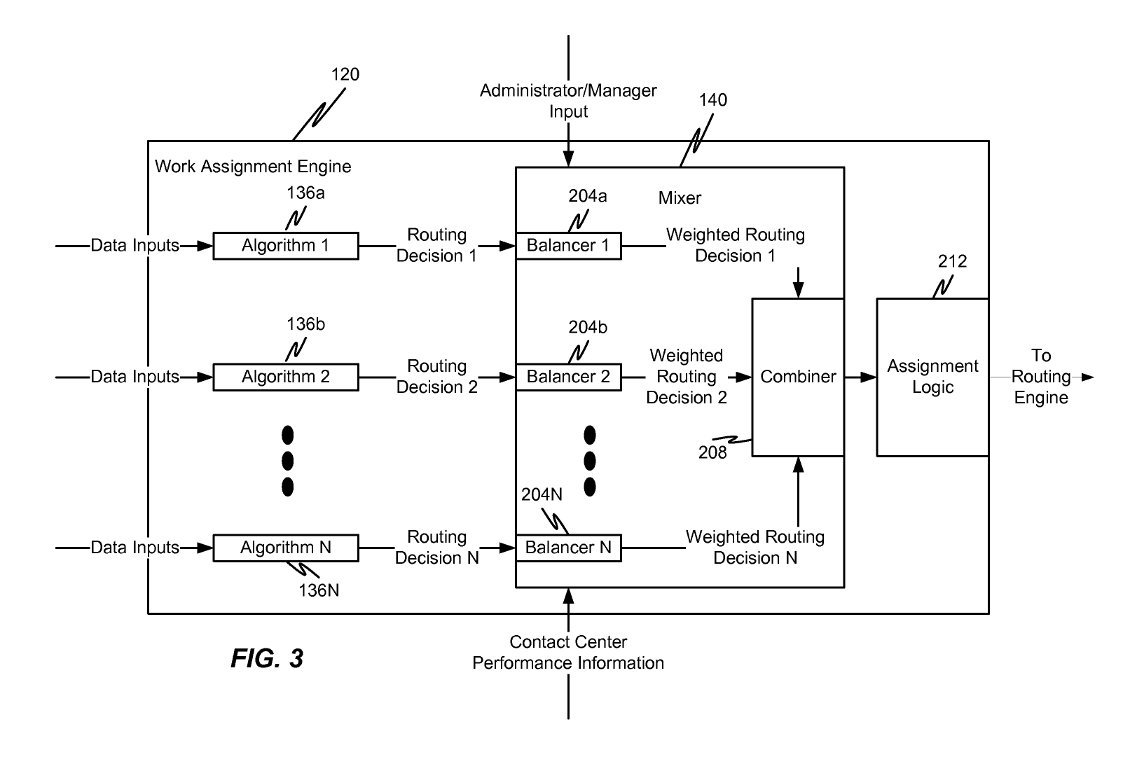

With reference now to FIG. 3, additional details of the work assignment engine 120 will be described in accordance with embodiments of the present disclosure. The algorithms 136a-N may each be configured to receive and analyze a different set of data inputs. The set of any particular data inputs provided to an algorithm 136a-N will depend upon the nature of the algorithm and the inputs that are required thereby. As noted above, however, the sets of inputs provided to each of the algorithms 136a-N may be provided from the same bitmap at the same instance in time, even though each algorithm 136a-N may receive or analyze different bits from the same bitmap. Alternatively, where bitmaps are not employed (e.g., in a contact center that employs the tradition notion of skill-based queues), the necessary inputs for each algorithm 136a-N may be computed at substantially the same time and provided to each algorithm 136a-N.

In some embodiments, one or more of the algorithms 136a-N may be time-sensitive algorithms that make work item routing decisions based on an analysis of time-based data inputs and the decisions are made in an attempt to satisfy time-based Service Level Objectives (e.g., maintain Average Wait Time below a predetermined threshold, answer X % of contacts within a predetermined amount of time, maintain all Wait Times below a predetermined maximum threshold, etc.). In some embodiments, others of the algorithms 136a-N may be quality/effectiveness-sensitive algorithms that make work item routing decisions based on an analysis of quality-based data inputs and the decisions are made in an attempt to satisfy quality-based Service Level Objectives (e.g., have at least Y average revenue, maintain customer satisfaction scores at or above a predetermined threshold, maintain transfers below a predetermined threshold for a predetermined percentage of contacts, etc.). Other types of algorithms 136a-N are well-known and are considered to be within the scope of the present disclosure. In particular, embodiments of the present disclosure can employ any type of algorithm 136a-N that is known or yet to be developed.

As can be appreciated, the set of data inputs provided to a time-sensitive algorithm may not necessarily be co-extensive with the set of data inputs provided to a quality-sensitive algorithm. In some embodiments, however, one or more data inputs in a set of data inputs provided to one algorithm may also be provided as a data input to another algorithm. In other words, there is no need to limit the ability of a single input to be provided to only one algorithm. Rather, each algorithm 136a-N may be configured to operate as if it were the only algorithm being employed by the work assignment engine 120. This means that a single data input may be provided to multiple different work assignment algorithms 136a-N in each algorithm's respective set of data inputs.

Each algorithm 136a-N may also be configured to apply a different logic to the set of data inputs it receives. Accordingly, there may be circumstances where two different algorithms receive the same set of data inputs but one algorithm applies a first logic to the set of data inputs to make a first routing decision and another algorithm applies a second logic to the same set of data inputs to make a second routing decision that is different from the first routing decision. Thus, each algorithm 136a-N is configured to independently make its own routing decision.

The routing decisions from each algorithm 136a-N are provided to the mixer 140 and are received at a balancer 204a-N that has been allocated to a specific algorithm 136a-N. Of course, the routing decisions may all be provided to a common balancer that is capable of individually processing the routing decisions and applying different weights or ratios thereto.

In some embodiments, the mixer 140 may be configured to receive contact center performance information from the state monitor 124 as well as administrator/manager input. These inputs may influence the way in which the mixer 140 weighs the various routing decisions. In some embodiments, if the contact center is experience high traffic volume and one or more time-sensitive Service Level Objectives are not being met, then the mixer 140 may consider routing decisions from time-sensitive algorithms with a greater weight than it considers routing decisions from non-time-sensitive algorithms (e.g., a quality-sensitive algorithm). In some embodiments, if the contact center is not experiencing high traffic volume and most or all time-sensitive Service Level Objectives are being met, then the mixer 140 may consider routing decisions from quality-sensitive algorithms with a greater weight than it considers routing decisions from non-quality-sensitive algorithms (e.g., a time-sensitive algorithm).

It should be appreciated that depending upon the current state of the contact center and/or the manual inputs provided by an administrator/manager, the mixer 140 may alter the ratio of weights applied to each routing decision by each balancer 204a-N. In some embodiments, the balancers 204a-N may be configured to work collectively such that the sum weights applied to every routing decision is equal to 100%, for example.

Each of the weighted routing decisions may then be provided from the balancers 204a-N to a combiner 208. The combiner 208 may comprise logic which enables the mixer 140 to consider the weighted routing decisions and make a single routing decision based on such an analysis. In some embodiments, each routing decision may correspond to a single routing decision (e.g., routing decision 1=route work item A to agent 4, routing decision 2=route work item A to agent 3, and routing decision N=route work item A to agent 4). Depending upon the weights applied to each routing decision, the combiner 208 can determine which routing decision(s) and, therefore, which algorithm from the plurality of algorithms 136a-N to follow. Continuing the above example, if routing decisions 1, 2, and N were weighted according to the following: 20% for routing decision 1; 60% for routing decision 2; and 20% for routing decision N, then the combiner 208 may simply follow the routing decision with the greatest overall score (e.g., route work item A to agent 3 according to routing decision 2 because it has a 60% weight as compared to the combined 40% from routing decisions 1 and N which said to route work item A to agent 4).

If, however, the routing decisions 1, 2, and N were weighted differently according to the following: 33.33% for routing decision 1; 33.33% for routing decision 2; and 33.33% for routing decision N, then the combiner 208 may still follow the routing decision with the greatest overall score (e.g., route work item A to agent 4 according to routing decisions 1 and N because they have a combined 66.66% weight as compared to the weight of 33.33% from routing decision 2 which said to route work item A to agent 3).

It should be appreciated that the combiner 208 can apply any type of analysis, arbitration rules, business rules, etc. to make a single routing decisions based on the multiple weighted routing decisions. Furthermore, it may be possible that each routing decision may comprise more than a single decision. For example, each routing decision may provide a first/best alternative as well as a second/next-best alternative. The balancer 204 for such a multi-portion routing decision may assign an overall weight to the routing decision (e.g., 30%) and may further apply different portions of that overall weight to each portion of the routing decision (e.g., first/best alternative receives 80% of overall weight or 24% and second/next-best alternative receives 20% of overall weight or 6%). Again, different weighting and combining schemes may be employed without departing from the scope of the present disclosure. Moreover, the weights of the different routing decisions made by the different algorithms 136a-N do not necessarily need to sum to 100%, and do not even necessarily have to be reflected by percentages, or ratios. Rather, in accordance with embodiments of the present disclosure, raw scores or ranks can be used to apply different weights to each of the routing decisions.

The combiner 208 may analyze all of the weighted routing decisions from the balancers 204a-N and make a single routing decision for a single work item. That decision may be provided to an assignment logic portion 212 of the work assignment engine 120. The assignment logic portion 212 may be responsible for formatting and sending the instructions to the routing engine 132 to execute work assignment decision that has been made by the combiner 208.

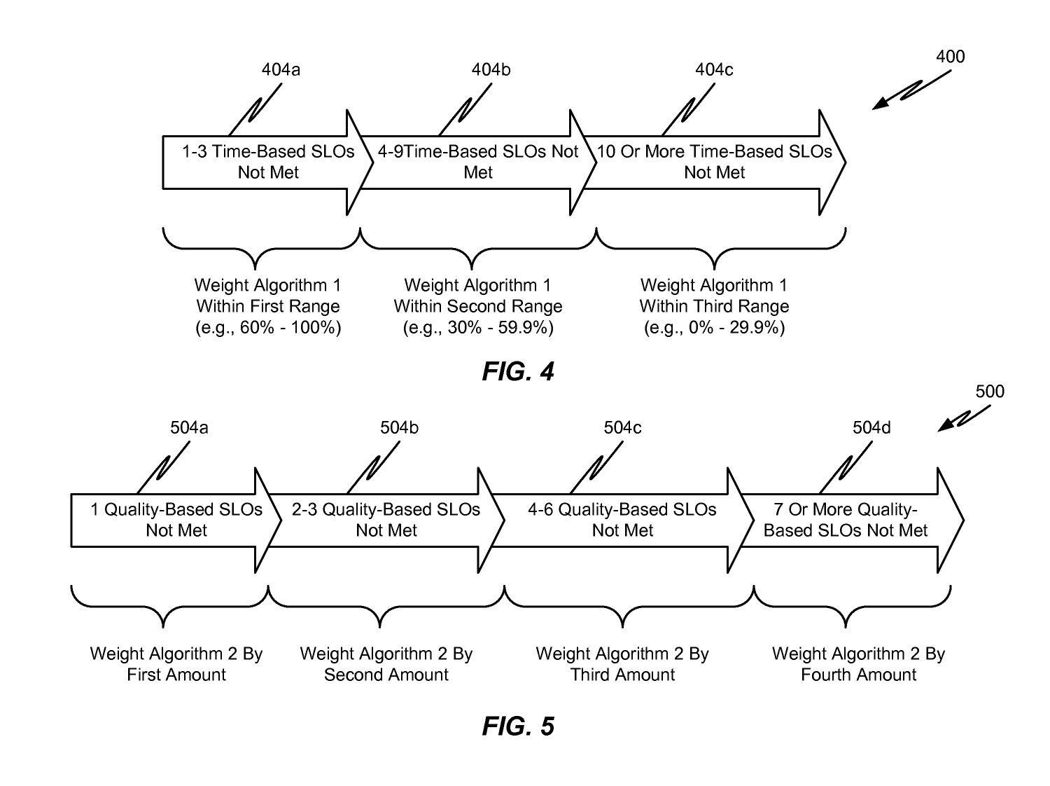

With reference now to FIG. 4, a first example of weighing routing decisions will be described in accordance with at least some embodiments of the present disclosure. Specifically, a first rule set 400 may be used to determine the amount by which a particular algorithm or set of algorithms should be weighted, discounted, etc. In particular, the first rule set 400 may be applied to weighting or discounting a quality-sensitive algorithm (e.g., first algorithm 136a) based on a current state of the contact center. A first portion 404a of the first rule set 400 may define that if a first amount of time-based Service Level Objectives are not being met (e.g., between 1 and 3), then the first algorithm 136a may be discounted within a first range or by a first amount (e.g., the routing decision received from the first algorithm 136a may be discounted by an amount that is between 60% and 100%). This first level of discounting the quality-sensitive algorithm may not be that significant since a relatively small number of time-based Service Level Objectives are not being met.

However, a second portion 404b of the first rule set 400 may define that if a second amount of the time-based Service Level Objectives are not being met (e.g., between 4 and 9), then the first algorithm 136a may be discounted by a second range or by a second amount (e.g., the routing decision received from the first algorithm 136a may be discounted by an amount that is between 30% and 59.9%). This second level of discounting the quality-sensitive algorithm may be more significant because time considerations may be increasingly important as evidenced by the fact that more time-based Service Level Objectives are not being met, which may be an indicator of increased traffic in the contact center.

A third portion 404c of the first rule 400 set may define that if a third amount of the time-based Service Level Objectives are not being met (e.g., more than 10), then the first algorithm 136a may be discounted by a third range or by a third amount (e.g., the routing decision received from the first algorithm 136a may be discounted by an amount that is between 0% and 29.9%). The additional discounting of the first algorithm 136a may help other non-quality-sensitive algorithms (e.g., time-sensitive algorithms) receive a greater relative weight when provided to the combiner 208, thereby increasing the likelihood that the combiner 208 will make a routing decision that aides efficiency rather than effectiveness.

As can be appreciated, there is no requirement that a rule set, such as the first rule set 400, have only three portions. Rather, a greater or lesser number of portions may be included in a rule set without departing from the scope of the present disclosure. Specifically, different weights or discounting rates may be applied for every Service Level Objective that is not met. Further still, certain Service Level Objectives may be considered more important than others (as defined by administrator/manager input), in which case if a higher priority Service Level Objective is not being met, the discounting rate to be applied to algorithms that would contradict meeting such a Service Level Objective may be greater than if a lower priority Service Level Objective is not being met.

With reference now to FIG. 5, a second example of weighing routing decisions will be described in accordance with at least some embodiments of the present disclosure. Specifically, a second rule set 500 may be used to determine the amount by which a particular algorithm or set of algorithms should be weighted, discounted, etc. In particular, the second rule set 500 may be applied to weighting or discounting a time-sensitive algorithm (e.g., second algorithm 136b) based on a current state of the contact center. A first portion 504a of the second rule set 500 may define that if a first amount of quality-based Service Level Objectives are not being met (e.g., 1), then the second algorithm 136b may be discounted within a first range or by a first amount (e.g., the routing decision received from the second algorithm 136b may be discounted by a first amount). This first level of discounting the time-sensitive algorithm may not be that significant since only one quality-based Service Level Objective is not being met.

A second portion 504b of the second rule set 500 may define that if a second amount of the quality-based Service Level Objectives are not being met (e.g., between 2 and 3), then the second algorithm 136b may be discounted by a second range or by a second amount (e.g., the routing decision received from the second algorithm 136b may be discounted by a second amount that is greater than the first amount). This second level of discounting the time-sensitive algorithm may be more significant because quality considerations may be increasingly important as evidenced by the fact that more quality-based Service Level Objectives are not being met.

A third portion 504c of the second rule set 500 may define that if a third amount of the quality-based Service Level Objectives are not being met (e.g., between 4 and 6), then the second algorithm 136b may be discounted by a third range or by a third amount (e.g., the routing decision received from the second algorithm 136b may be discounted by a third amount that is greater than the second amount).

A fourth portion 504d of the second rule set 500 may define that if a fourth amount of the quality-based Service Level Objectives are not being met (e.g., 7 or more), then the second algorithm 136 may be discounted by a fourth range or by a fourth amount (e.g., the routing decision received from the second algorithm 136b may be discounted by a fourth amount that is greater than the third amount). The increased discounting of the second algorithm 136b may help other non-time-sensitive algorithms (e.g., quality-sensitive algorithms) receive a greater relative weight when provided to the combiner 208, thereby increasing the likelihood that the combiner 208 will make a routing decision that aides effectiveness rather than efficiency.

In some embodiments, rule sets may be defined that simultaneously consider the number of time-based Service Level Objectives not being met at a first time as well as the number of quality-based Service Level Objectives not being met at the first time. As a non-limiting example, if the number of time-based Service Level Objectives not being met exceeds the number of quality-based Service Level Objectives not being met at a particular point in time, then discount rates may be applied more aggressively to quality-sensitive algorithms (e.g., as described in connection with the first rule set 400), thereby decreasing the influence of routing decisions received from quality-sensitive algorithms as compared to routing decisions received from time-sensitive algorithms. On the other hand, if the number of quality-based Service Level Objectives not being met exceeds the number of time-based Service Level Objectives not being met at a particular point in time, then discount rates may be applied more aggressively to time-sensitive algorithms (e.g., as described in connection with the second rule set 500), thereby decreasing the influence of routing decisions received from time-sensitive algorithms as compared to routing decisions received from quality-sensitive algorithms. Further still, if the number of quality-based Service Level Objectives not being met equals the number of time-based Service Level Objectives not being met, then it may not be necessary to apply any discounting rates to the routing decisions.

Even further still, it may be possible to consider Service Level Objective priorities when determining how to weigh or discount time-sensitive algorithms as compared to quality-sensitive algorithms. The priorities may be considered along, in connection with any of the above-described schemes, or in connection with other weighting schemes not explained in detail herein.

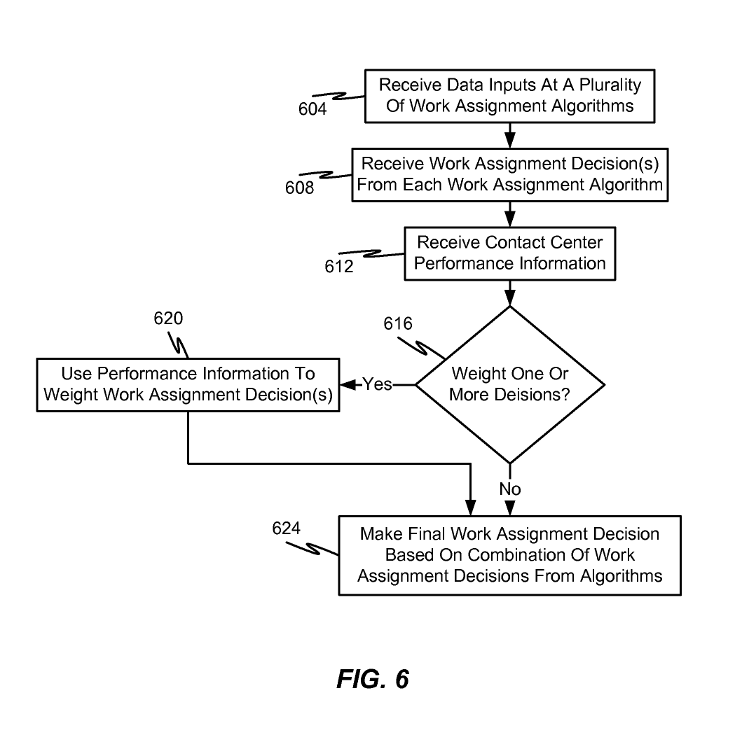

With reference now to FIG. 6, a work assignment method will be described in accordance with embodiments of the present disclosure. The method is initiated at a single instance of time where each algorithm 136a-N in the work assignment engine 120 receives its respective set of data inputs (step 604). An algorithm may be configured to consider a single input in its set of data inputs or multiple inputs in its set of inputs. Furthermore, the number of data inputs for one algorithm does not necessarily have to equal the number of data inputs for another algorithm. Further still, as noted above, a single data input may be included in sets of data inputs for multiple different algorithms.

Each work assignment algorithm 136a-N processes its respective set of data inputs according to its own logic and generates a routing decision. The routing decision for each algorithm 136a-N is received at the mixer 140 (step 608). The mixer 140 also receives contact center performance information, which describes the state of the contact center (e.g., high traffic, low traffic, behind schedule, failing to meet certain Service Level Objectives, etc.) (step 612). The mixer 140 analyzes the state of the contact center to determine if one or more of the routing decisions received from the algorithms 136a-N need to be weighted, discounted, or otherwise altered (step 616). If this query is answered affirmatively, then one or more of the routing decisions are weighted according to one or more rule sets that consider the contact center state as an input (step 620).

The routing decisions, whether weighted/discounted or not, are then provided to the combiner 208, where a final work assignment decision is made (step 624). The final work assignment decision is based on the combination of work assignment decisions received from the plurality of algorithms, where some of those decisions may have been weighed or discounted based on the current state of the contact center. This final work assignment decision is provided to the routing engine 132, which executes the results of the decision.

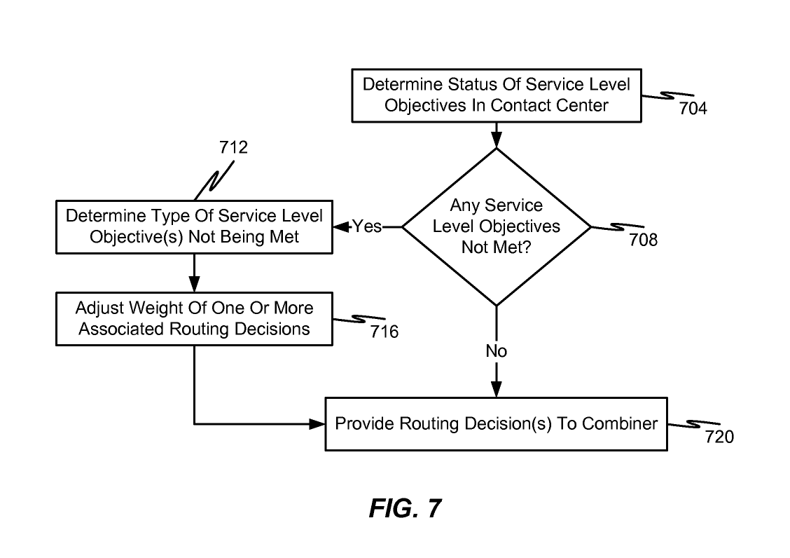

With reference now to FIG. 7, additional details of weighting or discounting routing decisions received from one or more work assignment algorithms 136a-N will be described in accordance with at least some embodiments of the present disclosure. The method begins with the state monitor 124 determining a status of one or more Service Level Objectives in the contact center 100 (step 704). In particular, the Service Level Objectives may be analyzed by comparing current performance information (e.g., KPIs, other metrics, etc.) with one or more stated goals or thresholds in the contact center. As can be appreciated, each Service Level Objective may be treated the same as other Service Level Objectives or priorities may be assigned to different Service Level Objectives depending upon their determined importance.

The state monitor 124 then determines the status of the contact center (e.g., based on whether one or more Service Level Objectives are not currently being met or are predicted to not be met within a predetermined amount of time) (step 708). If every Service Level Objective is being met, then the routing decisions may be provided to the combiner 208 without being weighted related to other routing decisions (step 720). Of course, a precursor to this step may involve weighting or discounting the routing decisions, but it may be achieved by equally weighting the routing decisions, regardless of whether or not they are time-sensitive or quality-sensitive.

If, however, the query of step 708 is answered affirmatively (e.g., one or more Service Level Objectives are not being currently met), then the method may continue with the balancers 204a-N applying different weighting or discounting rates to the various routing decisions. Specifically, the method may continue by determining the type of Service Level Objective(s) that are not being met (e.g., quality-based or time-based) (step 712). Based on the type of Service Level Objective(s) not being met and/or the relative number of a certain type of objective not being met as compared to another type of objective, the balancers 204a-N may adjust the different routing decisions differently to accommodate or account for the current state of the contact center (step 716). Thereafter, the method proceeds to step 720 where the weighted routing decisions are provided to the combiner 208.

It should be appreciated that while embodiments of the present disclosure have been described in connection with a queueless contact center architecture, embodiments of the present disclosure are not so limited. In particular, those skilled in the contact center arts will appreciate that some or all of the concepts described herein may be utilized in a queue-based contact center or any other traditional contact center architecture.

Furthermore, in the foregoing description, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor (GPU or CPU) or logic circuits programmed with the instructions to perform the methods (FPGA). These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

Specific details were given in the description to provide a thorough understanding of the embodiments. However, it will be understood by one of ordinary skill in the art that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Also, it is noted that the embodiments were described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium such as storage medium. A processor(s) may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents.

Information, arguments, parameters, data, etc. may be passed, forwarded, or transmitted via any suitable means including memory sharing, message passing, token passing, network transmission, etc.

While illustrative embodiments of the disclosure have been described in detail herein, it is to be understood that the inventive concepts may be otherwise variously embodied and employed, and that the appended claims are intended to be construed to include such variations, except as limited by the prior art.

1. A method, comprising:
receiving a first work item routing decision from a first work assignment algorithm, the first work item routing decision being made by the first work assignment algorithm based on the first work assignment algorithm receiving a first set of inputs and processing the first set of inputs according to a first logic;
receiving a second work item routing decision from a second work assignment algorithm, the second work item routing decision being made by the second work assignment algorithm based on the second work assignment algorithm receiving a second set of inputs and processing the second set of inputs according to a second logic that is different than the first logic;
determining a current state of a contact center; and
based on the current state of the contact center, making a final work item routing decision that is based on a weighted combination of the first and second work item routing decisions, the final work item routing decision corresponding to the first work item routing decision when the current state of the contact center is in a first state and the final work item routing corresponding to the second work item routing decision when the current state of the contact center is in a second state.

2. The method of claim 1, wherein the current state of the contact center is determined by determining whether one or more Service Level Objectives are being met.

3. The method of claim 2, further comprising:
determining that a first Service Level Objective is not being met;
determining a type of the first Service Level Objective; and
adjusting an amount by which the first work item routing decision is weighted relative to the second work item routing decision based on the type of the first Service Level Objective.

4. The method of claim 3, wherein the first Service Level Objective corresponds to a time-based Service Level Objective, wherein the first work assignment algorithm corresponds to quality-sensitive algorithm, wherein the second work assignment algorithm corresponds to a time-sensitive algorithm, and wherein the first work item routing decision is discounted relative to the second work item routing decision.

5. The method of claim 3, wherein the first Service Level Objective corresponds to a quality-based Service Level Objective, wherein the first work assignment algorithm corresponds to time-sensitive algorithm, wherein the second work assignment algorithm corresponds to a quality-sensitive algorithm, and wherein the first work item routing decision is discounted relative to the second work item routing decision.

6. The method of claim 3, further comprising:
determining that a second Service Level Objective is not being met;
determining a type of the second Service Level Objective; and
further adjusting an amount by which the first work item routing decision is weighted relative to the second work item routing decision based on the type of the second Service Level Objective

7. The method of claim 6, wherein the second Service Level Objective comprises a priority that is greater than the first Service Level Objective, wherein the second Service Level Objective is of a different type than the first Service Level Objective, and wherein the type of the second Service Level Objective control the amount by which the first work item routing decision is weighted relative to the second work item routing decision.

8. The method of claim 1, wherein a first data input is included in the first set of inputs and the second set of inputs.

9. The method of claim 1, wherein the first set of inputs is not co-extensive with the second set of inputs.

10. The method of claim 1, wherein the first work assignment algorithm is a time-sensitive algorithm and wherein the second work assignment algorithm is a quality-sensitive algorithm.

11. A non-transitory computer readable medium having stored thereon instructions that cause a computing system to execute a method, the instructions comprising:
instructions configured to receive a first work item routing decision from a first work assignment algorithm, the first work item routing decision being made by the first work assignment algorithm based on the first work assignment algorithm receiving a first set of inputs and processing the first set of inputs according to a first logic;
instructions configured to receive a second work item routing decision from a second work assignment algorithm, the second work item routing decision being made by the second work assignment algorithm based on the second work assignment algorithm receiving a second set of inputs and processing the second set of inputs according to a second logic that is different than the first logic;
instructions configured to determine a current state of a contact center; and
instructions configured to, based on the current state of the contact center, make a final work item routing decision that is based on a weighted combination of the first and second work item routing decisions, the final work item routing decision corresponding to the first work item routing decision when the current state of the contact center is in a first state and the final work item routing corresponding to the second work item routing decision when the current state of the contact center is in a second state.

12. The computer readable medium of claim 11, wherein the first work item routing decision is not the same as the second work item routing decision, wherein the first work item routing decision comprises a weight that is greater than a weight of the second work item routing decision, and wherein the final work item routing decision equals the first work item routing decision.

13. The computer readable medium of claim 11, further comprising instructions configured to receive a third work item routing decision from a third work assignment algorithm, the third work item routing decision being made by the third work assignment algorithm based on the third work assignment algorithm receiving a third set of inputs and processing the third set of inputs according to a third logic that is different than the first and second logic, wherein the first work item routing decision is not the same as the second work item routing decision, wherein the second work item routing decision is the same as the third work item routing decision, wherein the first work item routing decision comprises a weight that is greater than a weight of the second work item routing decision, wherein the first work item routing decision comprises a weight that is greater than a weight of the third work item routing decision, wherein a sum of the weights of the second and third work item routing decisions is greater than the weight of the first work item routing decision, and wherein the final work item routing decision equals the second work item routing decision.

14. The computer readable medium of claim 11, wherein the current state of the contact center is determined by determining whether one or more Service Level Objectives are being met.

15. The computer readable medium of claim 11, wherein the first set of inputs is the same as the second set of input and wherein the first work item routing decision is different from the second work item routing decision.

16. The computer readable medium of claim 11, wherein the first work assignment algorithm is a time-sensitive algorithm and wherein the second work assignment algorithm is a quality-sensitive algorithm.

17. The computer readable medium of claim 11, wherein an amount by which the first work item routing decision is weighted relative to the second work item routing decision depends upon a number of Service Level Objectives that are not being met at the time that the first and second work item routing decisions are made.

18. A contact center, comprising:
a work assignment mechanism including:
a work assignment engine including a first work assignment algorithm and a second work assignment algorithm, the first work assignment algorithm being configured to make a first work item routing decision based on a processing of a first set of inputs according to a first logic, the second work assignment algorithm being configured to make a second work item routing decision based on a processing of a second set of inputs according to a second logic that differs from the first logic; and
a state monitor configured to determine a current state of the contact center and provide instructions to the work assignment engine that cause the work assignment engine to, based on the current state of the contact center, make a final work item routing decision that is based on a weighted combination of the first and second work item routing decisions, the final work item routing decision corresponding to the first work item routing decision when the current state of the contact center is in a first state and the final work item routing corresponding to the second work item routing decision when the current state of the contact center is in a second state.

19. The contact center of claim 18, wherein the first work item routing decision is not the same as the second work item routing decision, wherein the first work item routing decision comprises a weight that is greater than a weight of the second work item routing decision, and wherein the final work item routing decision equals the first work item routing decision.

20. The contact center of claim 18, wherein the current state of the contact center is determined by determining whether one or more Service Level Objectives are being met.
